(19) United States
(12) Patent Application Publication
(10) Pub. No.: US 2026/0138886 A1
(43) Pub. Date: May 21, 2026

(54) CATHODE ACTIVE MATERIAL AND A METHOD OF PREPARING THEREOF

(71) Applicant: DeepWave, Inc., Santa Clara, CA (US)

(72) Inventors: Dae-kyu CHOI, Suwon-si (KR); Do-hyeong HAN, Suwon-si (KR)

(73) Assignee: DeepWave, Inc., Santa Clara, CA (US)

(21) Appl. No.: 18/949,296

(22) Filed: Nov. 15, 2024

(51) Int. Cl. C01G 53/00; H01M 4/02; H01M 4/04; H01M 4/36; H01M 4/505; H01M 4/525

(52) U.S. Cl. CPC C01G 53/82; H01M 4/0459; H01M 4/0471; H01M 4/362; H01M 4/505; H01M 4/525; C01P 2004/61; H01M 2004/028

(57) ABSTRACT

Provided are a cathode active material and a method of preparing the same. The method of preparing a cathode active material includes a mixture preparation step of mixing a precursor with a lithium compound, an ion-generating step of generating lithium ions from the mixture so that the lithium ions permeate into the precursor, and a calcination step of calcining the precursor into which the lithium ions have been permeated.

### BACKGROUND OF THE INVENTION

### 1. Field of the Invention

The present disclosure relates to a cathode active material and a method of preparing the same.

### 2. Description of the Related Art

In general, the main components of a secondary battery can be characterized as a cathode material, an anode material, an electrolyte and a separator. A lithium metal composite oxide is mainly used as a cathode active material of a secondary battery. For example, a lithium metal composite oxide is prepared by mixing a transition metal precursor and a lithium-containing compound and then calcining the mixture.

It is known that secondary battery performance, such as energy density, power density, lifespan, stability, and cost, is affected by the characteristics of a cathode active material. In addition, the application fields of secondary batteries are expanded to electric vehicles beyond small electronic devices, thus increasing the demand for secondary batteries with higher electric capacity and longer lifespan. Research and development are being conducted on cathode active materials that can be applied to larger secondary batteries.

Conventionally, there is a problem that manufacturing positive electrode active materials takes a long time (e.g., more than 20 hours) due to processes such as stirring and calcination.

### SUMMARY OF THE INVENTION

Conventionally, a cathode active material of a secondary battery is formed by calcining a mixture of a transition metal precursor and a lithium-containing compound at high temperatures to form a lithium metal composite oxide. It is known that fine crystals are formed when calcined at 800° C. or higher for about 4 hours, and that the crystals grow when calcined for 10 hours or more. However, this method takes a long time to manufacture, which increases manufacturing costs. Moreover, the resulting particle size distribution and/or structure may affect the properties of a cathode active material.

The present disclosure has been made in view of the above problems, and it is an object of the present disclosure to provide a cathode active material that exhibits sufficient energy density, power density, lifespan, stability, etc. while reducing manufacturing costs.

It is another object of the present disclosure to provide a method for manufacturing a cathode active material that can reduce the manufacturing time and cost, improve yield, and provide a cathode material for a secondary battery exhibiting excellent performance.

It will be understood that the technical problems of the present disclosure are not limited to the aforementioned problems and other technical problems not referred to herein will be clearly understood by those skilled in the art from disclosures below.

In accordance with the present disclosure, the above and other objects can be accomplished by the provision of a method of preparing a cathode active material, the method including: a mixture preparation step of mixing a precursor with a lithium compound; an ion-generating step of generating lithium ions from the mixture so that the lithium ions permeate into the precursor; and a calcination step of calcining the precursor into which the lithium ions have been permeated.

The ion-generating step may include an electric field application step of applying an electric field or a magnetic field to the mixture.

In addition, the ion-generating step may include a liquefaction step of heating the precursor and the lithium compound to melt at least a portion of the lithium compound, before the electric field application step.

The mixture preparation step may include: a step of heating the precursor, and a step of mixing the heat-treated precursor with the lithium compound, and the ion-generating step includes: a liquefaction step of secondarily heating the mixture of the precursor and the lithium compound to melt at least a portion of the lithium compound.

The lithium compound may include one or more of Li₂CO₃, LiOH, LiNO₃, Li₂S, Li₂O, Li₃PO₄, LiC₂H₃O₂, LiF, Li₃N, or a mixture thereof.

The prepared cathode active material may include one or more of NCM, NCA, NCMX, LFP, LMFP, LMFPX, LTO, LMO, LNMO, LCO, or a mixture thereof.

In addition, the ion-generating step may further include a step of heat-treating the mixture before or after the electric field application step.

The calcination step may be initiated when a molar number (mol) of lithium ions relative to a molar number of the precursor is equal to or less than a reference value as a result of the ion-generating step.

The ion-generating step may be performed for 10 minutes or less, and the calcination step may be performed for 1 hour or less.

The mixture preparation step or the ion-generating step may further include a dopant introduction step, wherein the dopant is at least one element selected from among Al, Ni, Co, Mn, Mg, Na, Si, Cr, Fe, Sr, V, Zn, W, Zr, B, Ba, Sc, Cu, Ti, Mo, P, F, Ga, Ge, As, Se, Br, Nb, Tc, Ta, Y, La, Ru, Sn, Sm, Ca, In, S, and a combination thereof.

In accordance with another aspect of the present disclosure, there is provided a cathode active material produced by preparing a mixture of a precursor and a lithium compound and applying an electric field or a magnetic field to the mixture so that lithium ions are permeated into the precursor, and performing a calcination process.

The cathode active material may include first particles and second particles, wherein the first particles have a multi-particle structure in which single particles are aggregated, and the second particles have a single-particle structure.

The first particles may have an average particle diameter of about 5.0 μm to 15.0 μm, and the second particles may have an average particle diameter of about 2.0 μm to 5.0 μm.

In addition, the cathode active material may be generated by applying an electric field of 400 V/m or higher to the precursor for 5 minutes or more.

In accordance with yet another aspect of the present disclosure, there is provided a cathode active material, including first particles and second particles, wherein the first particles have a secondary particle structure in which a plurality of primary particles are aggregated, and, in any of the first particles, the primary particles have a uniform average particle diameter throughout.

The primary particles may have an average particle diameter of about 0.6 to 3.0 μm, and the secondary particles may have an average particle diameter of about 5.0 to 15.0 μm.

In addition, a density of lithium ions in the first particles may be evenly distributed throughout.

A first region may be located at a center of each of the first particles and a second region may be located on an edge side of the first region, wherein a ratio of an average particle diameter of primary particles in the second region to an average particle diameter of primary particles in the first region is from 0.8 to 1.2.

The first particles may further include a shell portion surrounding the secondary particle, both the primary particles and the shell portion may include lithium ions, and the primary particles and the shell portion may include an identical transition metal element.

The first particles or the second particles may include a coating layer formed on surfaces thereof, and a content of the coating layer may be from 0.4 to 1.0 wt % based on a total weight of the cathode active material, wherein the coating layer includes B, Al, P, Si, Ti, Mg, W, Y, Sr, Na, Cu, Fe, Ca, Zr, Nb, Ba, Co, Mn, or a combination thereof.

Specific details of other embodiments are included in the detailed description.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a flowchart illustrating a method of preparing a cathode active material according to an embodiment of the present disclosure;

FIG. 2 is a schematic diagram illustrating an ion-generating step of FIG. 1;

FIG. 3 is a schematic diagram illustrating a process temperature of an existing cathode active material manufacturing process and the binding of lithium ions and a precursor according to the process;

FIG. 4 is a schematic diagram illustrating a process temperature of the cathode active material preparation process according to the embodiment of FIG. 1 and the resultant binding between lithium ions and a precursor;

FIG. 5 is a flowchart illustrating a method of preparing a cathode active material according to another embodiment of the present disclosure;

FIG. 6 is a flowchart illustrating a method of preparing a cathode active material according to still another embodiment of the present disclosure;

FIG. 7 is a flowchart illustrating a method of preparing a cathode active material according to still another embodiment of the present disclosure;

FIG. 8 is a flowchart illustrating a method of preparing a cathode active material according to still another embodiment of the present disclosure;

FIG. 9 illustrates a structural schematic diagram of a cathode active material prepared according to an embodiment of the present disclosure;

FIGS. 10A and 10B illustrate microscope images of a lithium metal composite oxide prepared according to Preparation Example 1;

FIGS. 11A to 11C illustrate microscope images of a lithium metal composite oxide prepared according to Preparation Example 2;

FIGS. 12A to 12C illustrate microscope images of a lithium metal composite oxide prepared according to Preparation Example 3;

FIG. 13 illustrates a microscope image of a precursor used in Preparation Example 4;

FIGS. 14A to 14C illustrate microscope images of a lithium metal composite oxide prepared according to Preparation Example 4;

FIGS. 15A to 15C illustrate microscope images of a lithium metal composite oxide prepared according to Preparation Example 5;

FIG. 16 illustrates a microscope image of a lithium metal composite oxide prepared according to Comparative Example 2; and

FIGS. 17 and 18 are graphs illustrating charge/discharge results of Experimental Example 1.

### DETAILED DESCRIPTION OF THE INVENTION

Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided to convey the concept of the disclosure to those skilled in the art.

Various changes may be made to embodiments presented in the present disclosure. Examples described below are not intended to limit embodiments of the present disclosure, and should be understood to include all modifications, equivalents, or alternatives thereto.

As used herein, the term “and/or” includes any and all combinations of one or more of the associated listed items. As used herein, the singular forms “a”, “an” and “the” are intended to include the plural forms as well, unless clearly stated otherwise. It will be further understood that the terms “comprises” and/or “comprising,” when used in this specification, specify the presence of stated components, but do not preclude the presence or addition of one or more other components. A numerical range expressed using “to” indicates a numerical range including values stated before and after “to” as the lower and upper limits. A numerical range expressed using “about” or “approximately” indicates a value or a numerical range within 20% of the value or the numerical range stated after “about” or “approximately”.

In the drawings, the present disclosure is not limited to the illustrated form and components may be enlarged or reduced in size, thickness, width, length, and the like.

In this specification, when defining the diameter of a particle, the diameter of a non-circular particle may be understood as the diameter of a circle having an area equivalent to that of the particle.

Hereinafter, the present disclosure is described in detail with reference to the accompanying drawings.

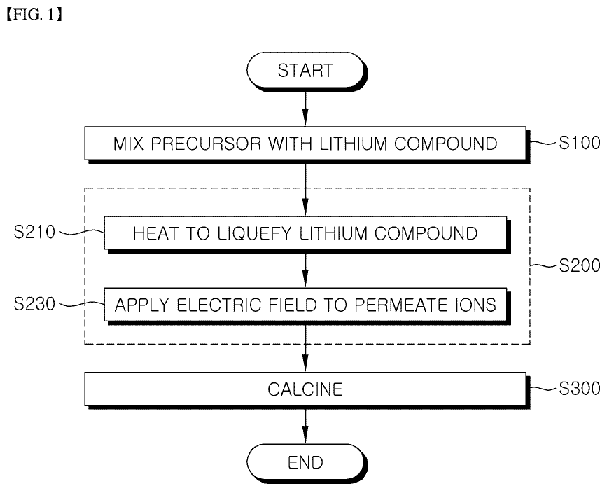

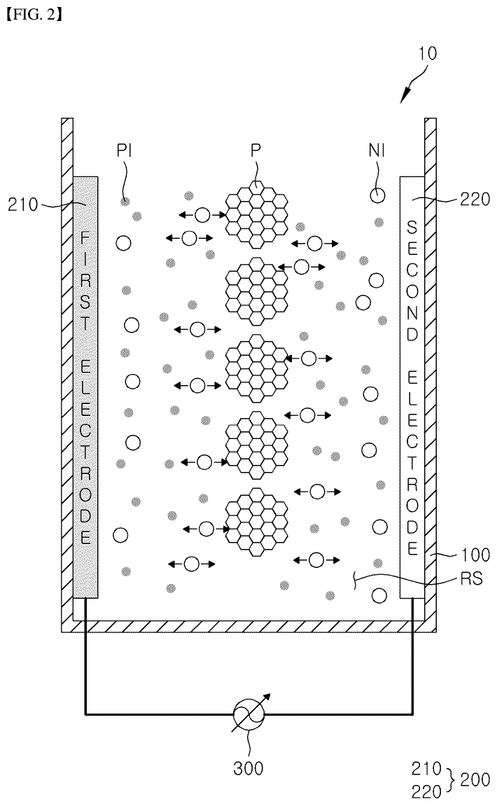

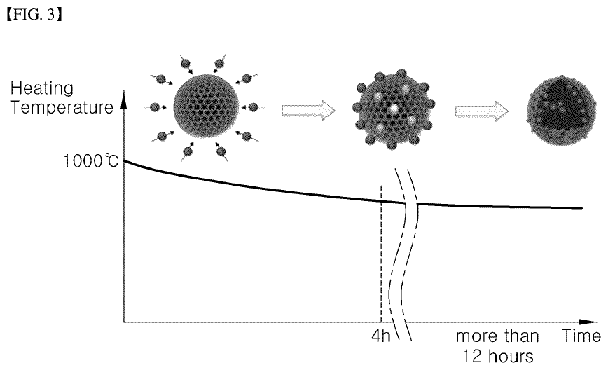

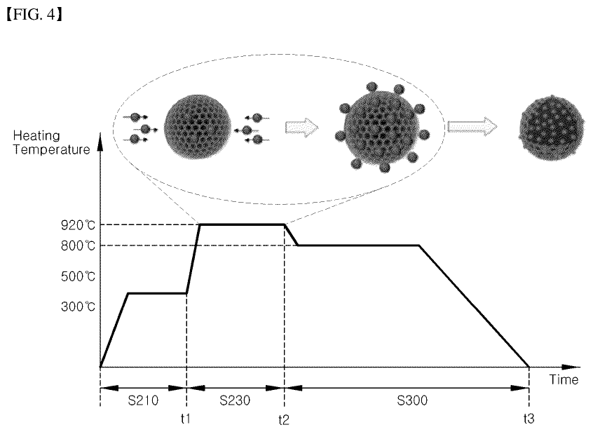

FIG. 1 is a flowchart illustrating a method of preparing a cathode active material according to an embodiment of the present disclosure. FIG. 2 is a schematic diagram illustrating an ion-generating step of FIG. 1. FIG. 3 is a schematic diagram illustrating a process temperature of an existing cathode active material manufacturing process and the binding of lithium ions and a precursor according to the process. FIG. 4 is a schematic diagram illustrating a process temperature of the cathode active material preparation process according to the embodiment of FIG. 1 and the resultant binding between lithium ions and a precursor, particularly a schematic diagram illustrating a process temperature change in a step after the ion-generating step.

Referring to FIGS. 1 to 4, the method (or the method of preparing a lithium metal composite oxide) of preparing a cathode active material according to this embodiment may include a mixture preparation step S100 of preparing a mixture of a precursor and a lithium compound; and an ion-generating step S200, and may further include a calcination step S300.

First, a precursor may be mixed with a lithium compound (S100). In some embodiments, a suitable solvent may be further mixed.

The precursor may provide the basic structure of the active material. The precursor may be a precursor including a transition metal or an iron phosphate metal compound. As a non-limiting example, the precursor may include titanium, manganese, nickel, cobalt, iron, aluminum, phosphorus, or an alloy of two or more thereof.

The lithium compound may be a source (supply source) of lithium ions. As the lithium compound, for example, lithium carbonate (Li₂CO₃), lithium hydroxide (LiOH), lithium nitrate (LiNO₃), lithium sulfide (Li₂S), lithium oxide (Li₂O), lithium phosphate (Li₃PO₄), lithium acetate (LiC₂H₃O₂), lithium fluoride (LiF), lithium nitride (Li₃N), or a combination thereof may be used. Lithium ions supplied from the lithium compound may be physically and/or chemically combined with the precursor through a process to be described below.

A mixing weight ratio of the precursor to the lithium compound may be about 1.0:0.8 to 1.0:1.2, about 1.0:0.9 to 1.0:1.1, or about 1.0:1.0.

The preparation method according to this embodiment may effectively permeate, diffuse, inject, bind, or coat the lithium compound-derived lithium ions into the precursor by ion-generating (or ion-heating) the mixture of the precursor and the lithium compound. Hereinafter, the ion-generating step S200 is described in detail.

The ion-generating step S200 may include a liquefaction step S210 of melting, dissolving, or liquefying a lithium compound; and an electric field-applying step S230 of applying an electric field or a magnetic field to the mixture so as to permeate, diffuse, inject, bind, or coat the lithium ions into the precursor.

First, the liquefaction step S210 of liquefying or melting at least a portion of the lithium compound may include a step of heating the inside of a chamber 100 (e.g., see FIG. 2). Although not shown in the drawings, the chamber 100 may be equipped with a temperature controller (not shown) such as a heater and may heat the chamber 100 using the temperature controller. The heating temperature may be appropriately selected considering the melting temperature of the lithium compound used, but may be, for example, about 100° C. or higher, about 150° C. or higher, about 200° C. or higher, about 250° C. or higher, or about 300° C. or higher. An upper limit of the heating temperature is not particularly limited, but may be, for example, about 800° C. or lower, about 600° C. or lower, or about 500° C. or lower. With regard to this, FIG. 4 exemplifies a heating temperature of about 400° C., but the present disclosure is not limited thereto. A process time t1 of the liquefaction step S210 is not particularly limited as long as liquefaction step S210 at least partially forms lithium ions, and may be several minutes to several tens of minutes.

As shown in FIG. 2, in this step, the lithium compound may be liquefied and/or dissolved in a solvent and form at least some cations PI (e.g., lithium ions) and anions NI. The anions NI may vary depending on the type of the lithium compound used.

In addition, an electric field may be applied to the lithium compound such that the lithium compound is in a state where it is at least partially ionized (S230). As a non-limiting example, heating provided by the temperature controller may be stopped in the electric field-applying step S230 after the above-described liquefaction step S210. In an exemplary embodiment, the ion-generating step S200 may be performed using an electric field. As shown in FIG. 2, the equipment 10 for performing the ion-generating step S200 according to this embodiment may include a chamber 100, an electric field-forming means 200 and a power source 300.

As described above, the chamber 100 may provide a space for receiving a precursor P; and anions NI and cations PI dissociated from the lithium compound.

The electric field-forming means 200 may include a first electrode 210 and second electrode 220 facing each other. In addition, the power source 300 may include one or more of an AC power source, a variable AC power source, a DC power source, a variable DC power source, or a combination thereof. The power source 300 may provide power to the first electrode 210 and the second electrode 220. For example, the power source 300 may provide AC power to the first electrode 210 and the second electrode 220. The frequency of the AC power may be about 1 MHz or less, for example, about 60 Hz to 120 Hz.

In a state where the precursor P and the ions NI and PI are accommodated inside the chamber 100, the polarity of the electric field formed inside the chamber 100 may be alternately changed as AC power is applied to the first electrode 210 and the second electrode 220 that face each other. Accordingly, the ions NI and PI, especially the cations PI (e.g., lithium ions), having charges located in the electric field, may move in the electric field and frequently collide or contact the precursor P. In addition, even if separate heat is not provided, heat is generated, and ionization may be accelerated. That is, depending on the behavior of the cations PI and the anions NI, heat may be generated, the temperature may further increase, and the melting or dissolution of the lithium source may further proceed. With regard to this, FIG. 4 exemplifies the temperature as approximately 920° C. in the electric field-applying step S230, but the present disclosure is not limited thereto.

Through the process, cations PI may effectively permeate or be diffused, injected, bound or coated into the inside or surface of the precursor P. As a non-limiting example, the electric field-applying step S230 according to this embodiment may be performed for several minutes to several tens of minutes. For example, the execution time (t2−t1) of the electric field-applying step S230 may be about 2 minutes to 10 minutes, about 3 minutes to 8 minutes, or about 4 minutes to 6 minutes.

An upper limit of a distance between the first electrode 210 and the second electrode 220 may be about 10 cm, about 8.0 cm, about 6.0 cm, or about 5.0 cm. When a distance between electrodes 210 and 220 is too large, the behavior of ions due to the application of power (e.g., AC) may be minimal. A lower limit of the distance between the electrodes 210 and 220 is not particularly limited, but may be, for example, about 1.0 cm, about 1.5 cm, or about 2.0 cm.

An electric field-applying step S230 according to another embodiment may be performed by a magnetic field rather than an electric field by the first electrode 210 and the second electrode 220 that face each other. For example, the ions NI and PI may also be moved by utilizing a change in an electric field generated by an alternating current flowing through a coil winding the chamber 100.

The first electrode 210 and the second electrode 220 may be positioned horizontally or vertically facing each other with respect to the ground, and the two electrodes do not necessarily have to be parallel, and the distance between the electrodes may not be constant. In addition, the two electrodes do not have to be straight, and may have a curved or bent shape.

Thus, according to this embodiment, ions NI and PI may be formed through heating, etc., ionization may further proceed within a short time through the ion-generating step S200 of utilizing the behavior of the ions NI and PI in an electric field, and the physical/chemical binding of the precursor P and ions, especially cations PI may be effectively induced.

Next, the ion-generated mixture may be calcinated (S300). The calcination step S300 may be performed at least once. When the calcination step S300 is performed multiple times, a calcination step may be distinguished by an atmosphere or temperature. A calcination step S300 may be substantially performed in an oxygen atmosphere, and the temperature of the calcination may be about 700° C. to 1,000° C., about 750° C. to 900° C., or about 800° C. to 850° C. The time (t3−t2) of the process referred to as the calcination step S300 may be several tens of minutes to several hours. For example, the time (t3−t2) may be in a range of about 10 minutes to 120 minutes, about 20 minutes to 90 minutes, or about 30 minutes to 60 minutes.

Although not shown in the drawings, a water treatment step and/or a grinding step may be further performed after the calcination step S300. In an exemplary embodiment, in the method of preparing a cathode active material, an upper limit of an execution time of a step, e.g., a step of heating to 800° C. or higher, understood as a calcination step, may be 120 minutes, 90 minutes, or 60 minutes. Alternatively, an upper limit of an execution time of a step, e.g., a step of heating to 200° C. or higher, understood as a thermal process performed before the water treatment or the grinding, may be 120 minutes, 90 minutes, or 60 minutes.

Thus, according to this embodiment, a cathode active material exhibiting characteristics similar to or higher than those of an existing technology can be provided even though the heating process time is about 120 minutes or less. This may be because the concentration of lithium ions permeating into a single particle can be substantially made uniform and even through the ion-generating step S200, but the present disclosure is not limited to any theory.

In other words, the reason why an existing preparation method performs calcination at a very high temperature, for example, 900° C. or higher, for a long time of 12 hours or more is to induce lithium ions to bind to a precursor in a diffusion manner, and since lithium ions diffuse from the surface, the concentration gradient wherein the density of lithium ions decreases as approaching the inside of the particle is formed. Therefore, the amount of lithium ions bound to the particle was limited.

In contrast, in the present disclosure, lithium ions are effectively permeated into the precursor during the electric field application, e.g., the ion-generating process, so that the lithium ions exist relatively evenly. Therefore, even if the calcination is performed for a relatively short time, a stable physical/chemical bond between the precursor and the lithium ions may be formed. In addition, the amount of lithium compound lost may be reduced by reducing the time of the calcination process, and as a result, lithium ions may be more effectively bound to the precursor than before even when using a smaller amount of lithium.

The cathode active material prepared according to this embodiment may be a lithium-metal composite oxide. For example, the lithium metal composite oxide may be referred to as or include Lithium Nickel Cobalt Manganese Oxide (NCM), Lithium Nickel Cobalt Aluminum Oxide (NCA), Lithium Nickel Cobalt Manganese (Doped with other metal X) Oxide (NCMX), Lithium Iron Phosphate (LFP), Lithium Manganese Iron Phosphate (LMFP), Lithium Manganese Iron Phosphate (Doped with other metal X) (LMFPX), Lithium Titanate (LTO), Lithium Manganese Oxide (LMO), Lithium Nickel Manganese Oxide (LNMO), Lithium Cobalt Oxide (LCO), or a combination thereof.

Hereinafter, other embodiments of the present disclosure are described. However, descriptions of steps substantially identical or similar to the aforementioned embodiment will be omitted, and these can be easily understood by those skilled in the art from the accompanying drawings.

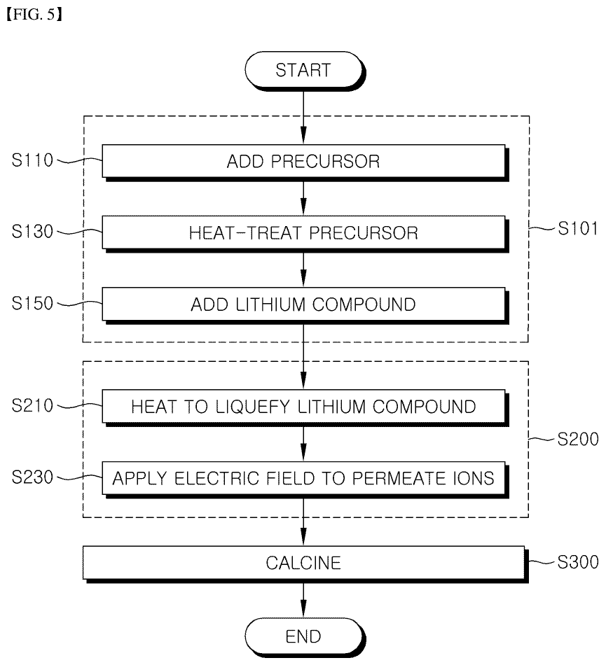

FIG. 5 is a flowchart illustrating a method of preparing a cathode active material according to another embodiment of the present disclosure.

Referring to FIG. 5, the method of preparing a cathode active material according to this embodiment includes a mixture preparation step S101 preparing a mixture of a precursor and a lithium compound, an ion-generating step S200, and a calcination step S300, and differs from the embodiment of FIG. 1, etc. in that the step S101 of mixing a precursor with a lithium compound further includes a step S130 of heat-treating the precursor.

Specifically, a precursor may be prepared and fed into a chamber (S110), and a lithium compound, e.g., a lithium-ion source, may be prepared and fed into the chamber (S150). In this case, before feeding the lithium compound (S150), the precursor may be heat-treated (S130). Accordingly, this may facilitate the bonding of lithium ions with the precursor, or may cause a physicochemical change in the precursor to facilitate ion penetration in the ion-generating step (S200). The heat treatment (S130) of the precursor may be performed at about 800° C. or higher, about 900° C. or higher, about 1,000° C. or higher, or about 1,500° C. or higher. The heat treatment may be performed for about 5 seconds or less, about 4 seconds or less, about 3 seconds or less, or about 2 seconds or less.

The heat-treating (S130) is not particularly limited, but may be performed, for example, using an arc plasma source or microwaves. When the precursor is preheated and ion-generating is performed before contacting the precursor with the lithium ions as in this embodiment, permeation of lithium ions may be more easily facilitated.

According to this embodiment, the heating step of the mixture of the precursor and the lithium compound in the ion-generating step S200 may be understood as a secondary heat treatment step.

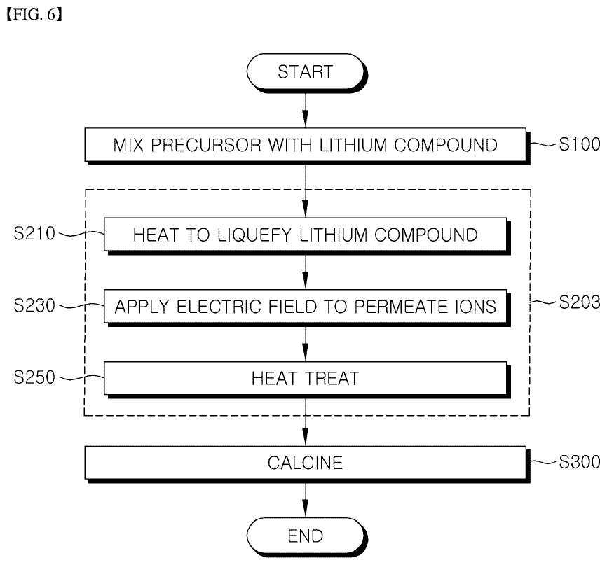

FIG. 6 is a flowchart illustrating a method of preparing a cathode active material according to still another embodiment of the present disclosure.

Referring to FIG. 6, the method of preparing a cathode active material according to this embodiment includes a mixture preparation step S100 of preparing a mixture of a precursor and a lithium compound, an ion-generating step S203, and a calcination step S300, and differs from the embodiment of FIG. 1, etc. in that the ion-generating step S203 further includes an additional heat treatment step S250.

Specifically, the mixture may be first heat-treated to melt, dissolve, or liquefy at least a portion of the lithium compound (S210), and an electric field may be applied to induce physical/chemical binding of the lithium ions and the precursor (S230), and then the secondary heat treatment step S250 may be performed. That is, the term “secondary heat treatment” in this embodiment means secondary heat treatment within the ion-generating step S203. The secondary heat treatment step S250 may be performed at about 500° C. or higher, about 800° C. or higher, about 1,000° C., or about 1,500° C. or higher. That is, according to this embodiment, the ion-generating step S203 includes at least two heating steps, specifically the first heat treatment in the liquefaction step S210 and the secondary heat treatment step S250. Here, the first heat treatment may be understood as being performed to ionize at least some of the lithium compound, and the secondary heat treatment may be understood as being intended for an already ionized mixture.

In another embodiment, the pre-heat treatment step described with reference to FIG. 5 may be performed in the mixture preparation step S100 in FIG. 6.

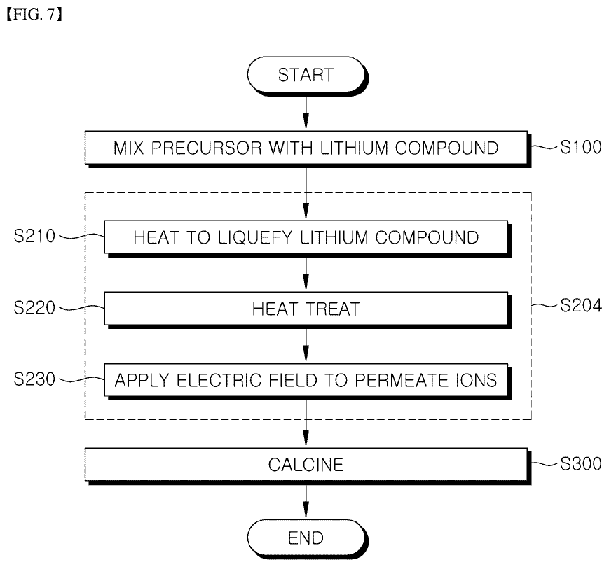

FIG. 7 is a flowchart illustrating a method of preparing a cathode active material according to still another embodiment of the present disclosure.

Referring to FIG. 7, the method of preparing a cathode active material according to this embodiment includes a mixture preparation step S100 of preparing a mixture of a precursor and a lithium compound, an ion-generating step S204, and a calcination step S300, and differs from the embodiment of FIG. 6 in that an additional heat treatment step S220 of the ion-generating step S204 is performed before the electric field-applying step S230.

In still another embodiment, the pre-heat treatment step described with reference to FIG. 5 may be performed in the mixture preparation step S100 in FIG. 7.

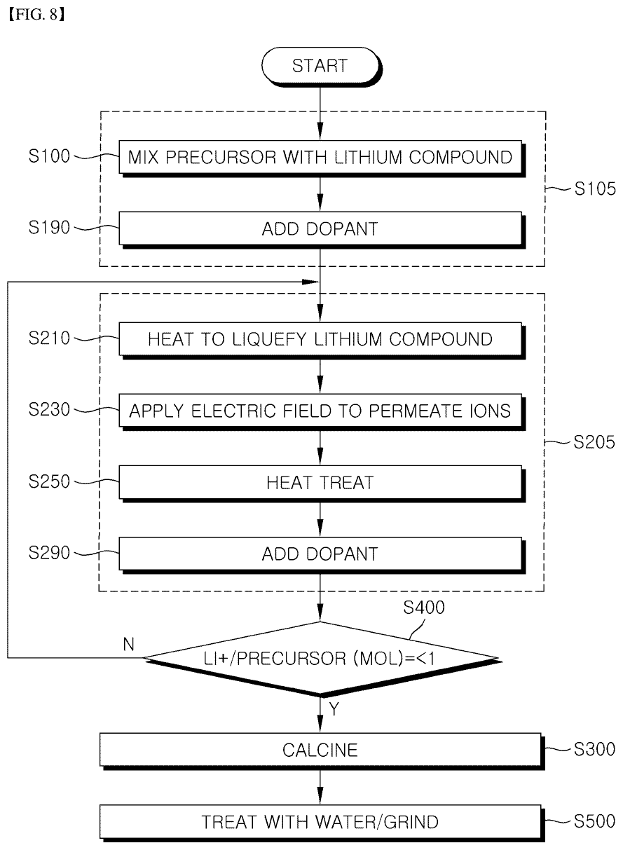

FIG. 8 is a flowchart illustrating a method of preparing a cathode active material according to still another embodiment of the present disclosure.

Referring to FIG. 8, the method of preparing a cathode active material according to this embodiment includes a mixture preparation step S105 of preparing a mixture of a precursor and a lithium compound, an ion-generating step S205, and a calcination step S300, and the calcination step is performed when predetermined conditions are satisfied.

The mixture preparation step S105 may further include a dopant injection step S190. For example, the added dopant may be one or more elements selected from among Al, Ni, Co, Mn, Mg, Na, Si, Cr, Fe, Sr, V, Zn, W, Zr, B, Ba, Sc, Cu, Ti, Mo, P, F, Ga, Ge, As, Se, Br, Nb, Tc, Ta, Y, La, Ru, Sn, Sm, Ca, In, S, and a combination thereof. That is, the mixture preparation step S105 in this embodiment may further include a dopant element.

In addition, the ion-generating step S205 may further include a dopant injection step S290. For example, the added dopant may be one or more elements selected from among Al, Ni, Co, Mn, Mg, Na, Si, Cr, Fe, Sr, V, Zn, W, Zr, B, Ba, Sc, Cu, Ti, Mo, P, F, Ga, Ge, As, Se, Br, Nb, Tc, Ta, Y, La, Ru, Sn, Sm, Ca, In, S, and a combination thereof.

That is, in this embodiment, the dopant injection step may be performed during the mixture preparation step S105, or may be performed once or more during the ion-generating step S205, and either the first dopant injection step S190 or the second dopant injection step S290 may be omitted.

In addition, a control device of the equipment, for example, a controller including a processor, may control whether to start a subsequent process based on the ion concentration and/or precursor concentration inside a chamber (S400). In an exemplary embodiment, control may be performed based on the concentration (or mole number) of cations in the chamber, for example, lithium ions, and the concentration (or mole number) of the precursor.

Specifically, if the concentration of lithium ions is not sufficiently low per determination step S400 after performing the ion-generating step S205, for example, if the concentration of lithium ions is greater than the concentration of a precursor, the ion-generating step S205 may be performed again. On the other hand, if the concentration of lithium ions is sufficiently low, or if the concentration of the precursor is sufficiently high, for example, if the concentration of lithium ions is less than or equal to the concentration of the precursor, the calcination step S300 may be performed. FIG. 8 illustrates a case where the concentration of lithium ions relative to the concentration of a precursor is compared with a numerical value (or a weight or a reference value) of 1, but the present disclosure is not limited thereto, and a numerical value (or a weight or a reference value) to be compared may be appropriately adjusted.

In some embodiments, the water treatment and/or grinding step S500 may be further performed after the calcination step S300 is completed.

Hereinafter, a cathode active material prepared according to the present disclosure is described in detail.

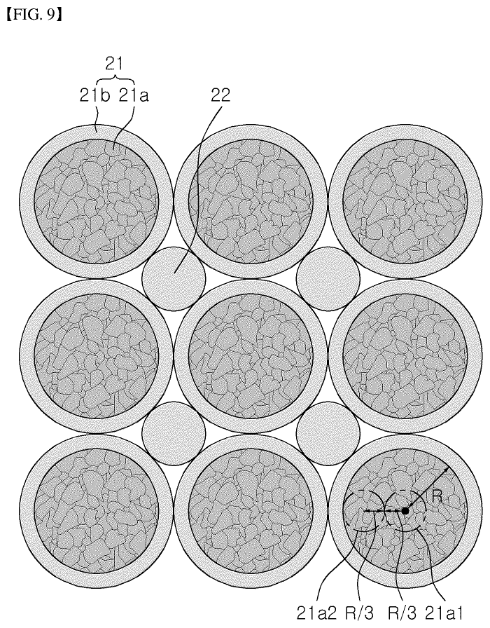

FIG. 9 illustrates a structural schematic diagram of a cathode active material prepared according to an embodiment of the present disclosure.

Referring to FIG. 9, the cathode active material according to this embodiment may include first particles 21 (or first cathode active material particles or a first lithium metal composite oxide) and second particles 22 (or second cathode active material particles or a second lithium metal composite oxide). The first particles 21 having a relatively large size may be particles prepared as described above, and the second particles 22 having a relatively small size may be particles prepared as described above. Alternatively, the first particles 21 and the second particles 22 may be derived from different precursors. For example, the first particles 21 may be derived from a precursor containing 70% to 90% of a nickel element among transition metals, and the second particles 22 may be derived from a precursor containing 50% to 70% of a nickel element among transition metals.

That is, the method of preparing a cathode active material according to the present disclosure may include a step of mixing lithium metal composite oxides obtained through different processes. Hereinafter, a cathode active material including both the first particles 21 and the second particles 22 is described as an example, but it is appreciated that the cathode active material according to the present disclosure may also include only one particle type of the first particles 21 and the second particles 22.

The first particles 21 may include a multi-particle portion 21a (e.g., a core portion or a secondary particle portion) located in the center; and a shell portion 21b surrounding the multi-particle portion 21a. The first particles 21 may have a relatively large size. An average particle size of an entire particle of the first particles 21, including the multi-particle portion 21a and the shell portion 21b, may be in a range of about 5.0 μm to 15 μm, or about 6.0 μm to 12.0 μm.

The multi-particle portion 21a is a portion formed by aggregation or agglomeration of multiple single particles (or primary particles), and may be understood as a secondary particle. An average particle diameter of respective single particles forming the multi-particle portion 21a may be in a range of about 0.6 μm to 3.0 μm, or about 0.6 μm to 1.5 μm.

Here, each single particle (first particle) forming the multi-particle portion 21a may be grown by lithium ions penetrating the precursor. As described below, lithium ions may substantially evenly permeate from the surface of the multi-particle portion 21a of the first particles 21 prepared according to the present disclosure toward the inner center thereof, and accordingly, the sizes of respective single particles may also be evenly distributed.

For example, the concentration of lithium ions in the center of the first particles 21 and the concentration of lithium ions in a relatively outer portion thereof may be substantially the same or within a difference range of +20% or within a difference range of about +15%. As a non-limiting example, in the cross-section of the first particles 21 that are understood to be spherical shape with a radius of about R, the concentration of lithium ions in a first circular region 21al having a radius of R/3 (or R/6) based on the center of the first particles 21, and the concentration of lithium ions in a second circular region 21a2, which has a radius of R/3 (or R/6), is located outside the first region 21al and does not overlap with the first region 21al, may be substantially the same or within a difference range of ±20%.

In an exemplary embodiment, the sizes (e.g., the particle diameters) of single particles in the center of the first particle 21 and in a relatively outer portion, may be substantially the same, within a difference range of ±20%, or within a difference range of about ±15%. The particle diameter of a single particle (first particle) selected in the first region 21al and the particle diameter of another single particle selected in the second region 21a2 may be substantially the same or within a ±20% range. In some embodiments, an average particle diameter of single particles observed in the first region 21al and an average particle diameter of single particles observed in the second region 21a2 may be substantially the same or within a ±20% difference range. In some embodiments, the particle size of a particle having the largest particle size among single particles observed in the first region 21al and the particle size of a particle having the smallest particle size among single particles observed in the second region 21a2 may be substantially the same or within a difference range of ±20%. In some embodiments, the particle size of a particle having the smallest particle size among single particles observed in the first region 21al and the particle size of a particle having the largest particle size among single particles observed in the second region 21a2 may be substantially the same or within a difference range of ±20%.

In addition, the shell portion 21b may be a layer portion surrounding the multi-particle portion 21a. Some single particles located at the outer periphery of the multi-particle portion 21a and the shell portion 21b may not have physical boundaries at least partially. That is, the multi-particle portion 21a does not have a physical boundary with at least some of the single particles, but may be recognized as a shell layer in the cross-sectional shape of the entire first particles 21. In some embodiments, the minimum thickness of the layer of the shell portion 21b may be about 0.4 μm or more. In some embodiments, the maximum layer thickness of the shell portion 21b may be about 1.0 μm or less. The single particles of the multi-particle portion 21a and the shell portion 21b may both include lithium ions, and the single particles of the multi-particle portion 21a and the shell portion 21b may include substantially the same transition metal element.

Meanwhile, the second particles 22 may be a small particle and may have a single-particle structure itself. An average particle diameter of the second particles 22 may be in a range of about 2.0 μm to 5.0 μm, or about 3.0 μm to 5.0 μm.

As described above, the first particles 21 may have a secondary particle structure in which multiple single particles are aggregated, and the second particles 22 may exist in a single particle state. Here, the average particle diameter of the first particles 21 may be larger than the average particle diameter of the second particles 22, and the average particle diameter of any single particles included in the first particles 21 may be smaller than the average particle diameter of the second particles 22.

FIG. 9 illustrates second particles 22 interposed between a plurality of first particles 21, but the present disclosure is not limited thereto. A cathode active material according to this embodiment may have a layered structure, a spinel structure, or an olivine structure.

Although not shown in the drawings, at least some of the first particles 21 and the second particles 22 may further include a coating layer formed on the surfaces thereof. That is, a coating layer may be placed on the surface of the lithium metal composite oxide. In some embodiments, the coating layer may include B, Al, P, Si, Ti, Mg, W, Y, Sr, Na, Cu, Fe, Ca, Zr, Nb, Ba, Co, Mn, or a combination thereof. The coating layer may suppress side reactions with an electrolyte and/or gas generation, and contribute to excellent life characteristics, e.g., lifespan.

The content of the coating layer may be in a range of about 0.4 wt % to 1.0 wt % relative to the total weight of the cathode active material including the coating layer.

Hereinafter, preparation examples of the present disclosure are described.

### Preparation Example 1

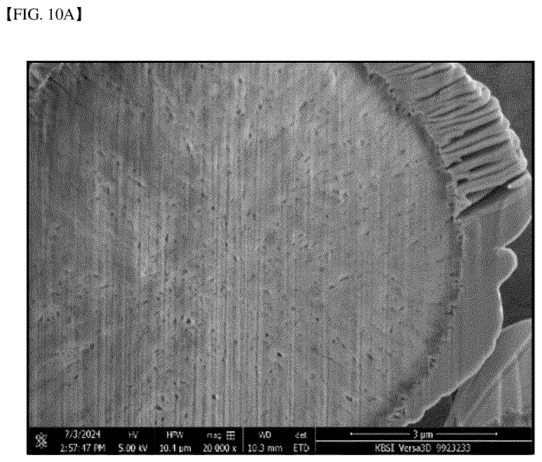

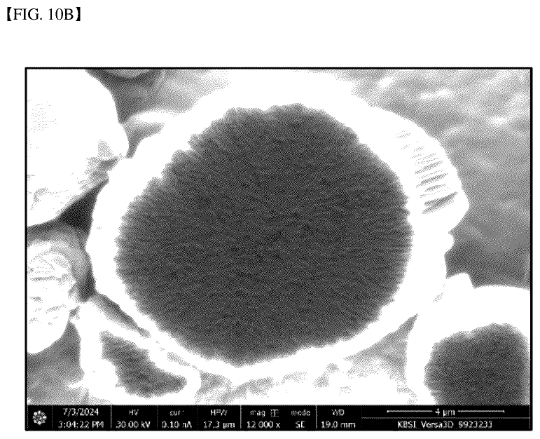

NCM811 (Ni 80-Co 10-Mn 10) was prepared as a precursor. FIG. 10A is an electron beam microscope image of the precursor, and FIG. 10B is an ion beam microscope image of the precursor. FIGS. 10A and 10B illustrate a precursor into which lithium ions do not permeate. In these images, crystals grown due to the permeation of lithium ions are not confirmed.

### Preparation Example 2

Lithium nitrate was prepared as a lithium compound (lithium source). 40 g of the precursor used in Preparation Example 1 and 40 g of lithium nitrate were mixed in a ratio of 1:1 in a chamber and heated at 400° C. for 10 minutes to dissolve the lithium compound. Aluminum was used as an electrode, but various metals such as Ag, Au, Ti, Ta, etc. may be used.

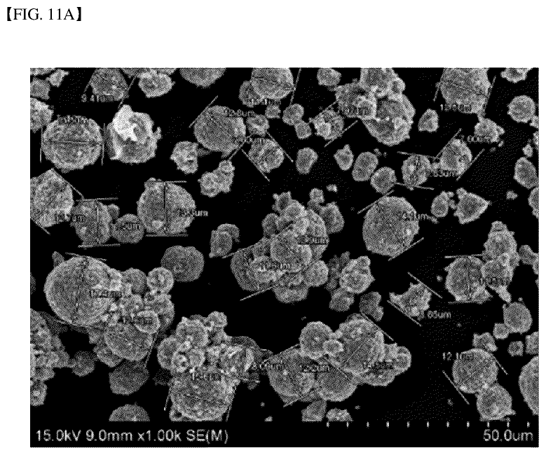

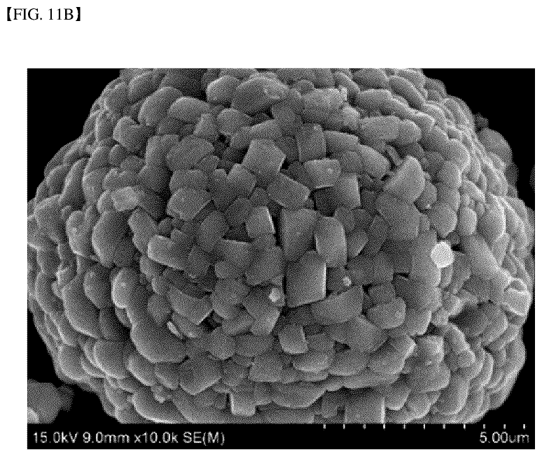

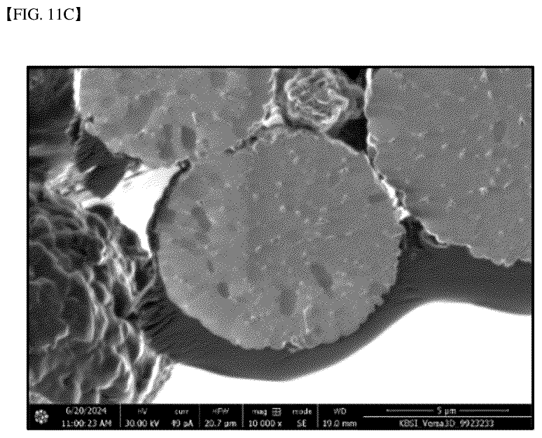

Next, heating was stopped, and AC power was applied to the opposing electrodes placed in the chamber for 5 minutes. A distance between the electrodes was 2.5 cm, and 9 V, 60 Hz electricity was applied. Even though a heating heater was not operated, the mixture inside the chamber was heated while power was applied, and the temperature increased to 920° C. A product generated by ion-generating was then calcined at 800° C. for 30 minutes. Microscope images of the calcinated product using an SEM microscope (Hitachi/SU8230) and an FIB microscope (Thermo Fisher Scientific/FEI versa 3D) were collected and are shown in FIGS. 11A to 11C.

Referring to FIGS. 11A to 11C, the obtained product, e.g., the lithium metal composite oxide, had a secondary particle (multi-particle) structure where primary particles (single particles) were aggregated. The average particle diameter of the secondary particles was about 10 μm. In addition, it can be confirmed that the size of the internal primary particles (shaded part) and the density of lithium ions associated with the particle size are generally even and uniform.

### Preparation Example 3

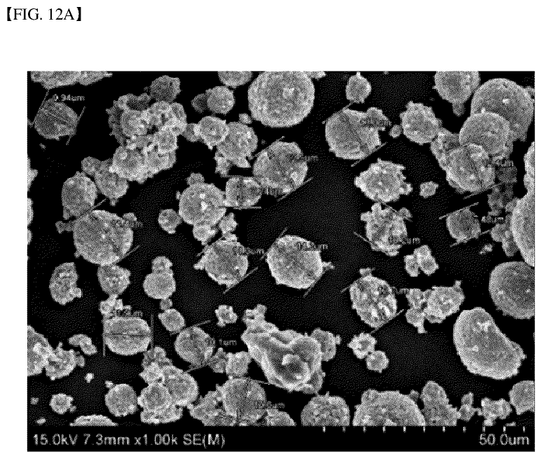

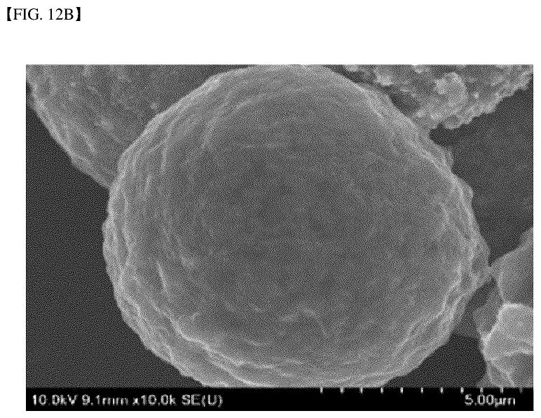

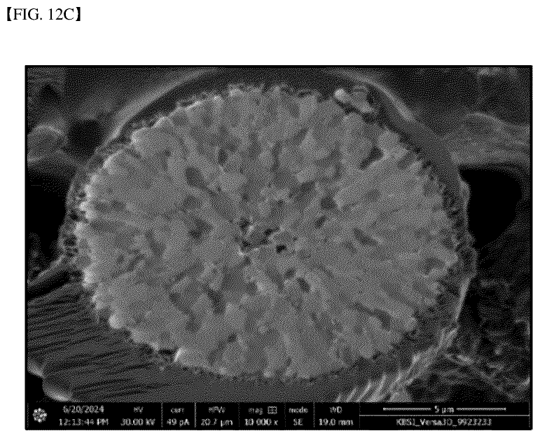

A product was obtained in the same manner as in Preparation Example 2, except that the precursor was heated to 2,000° C. or higher for about 5 seconds using a plasma source before mixing the precursor with the lithium compound. Plasma was applied with 4.5 to 5.5 kW power under atmospheric pressure using a nitrogen gas. Microscope images of the calcined product are shown in FIGS. 12A to 12C.

Referring to FIGS. 12A to 12C, the lithium metal composite oxide generally had a secondary particle structure where primary particles were aggregated, and the average particle diameter of the secondary particles was about 9 μm as in Preparation Example 2, which was not significantly different from Preparation Example 2. In addition, fine shells surrounding the secondary particle were observed. Compared to Preparation Example 2, the primary particles had longer shapes and tended to be oriented toward the center.

Similar to Preparation Example 2, it can be confirmed that the sizes of the internal primary particles are generally even and uniform.

### Preparation Example 4

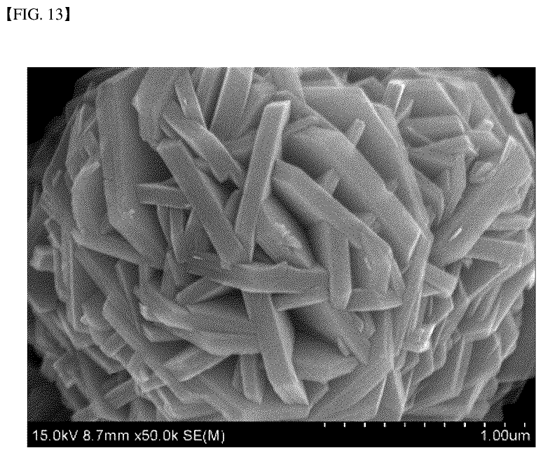

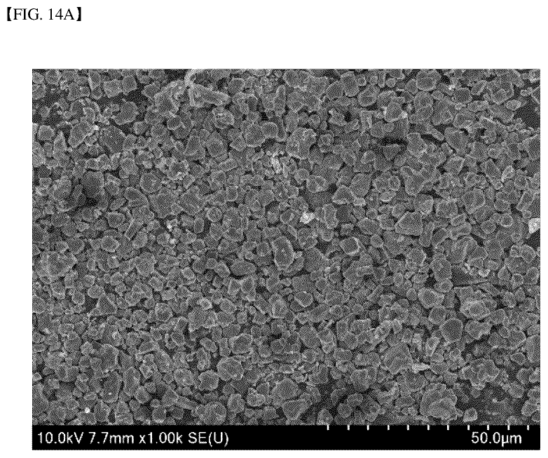

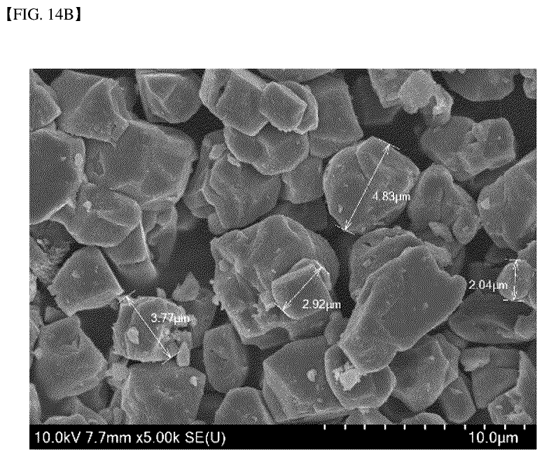

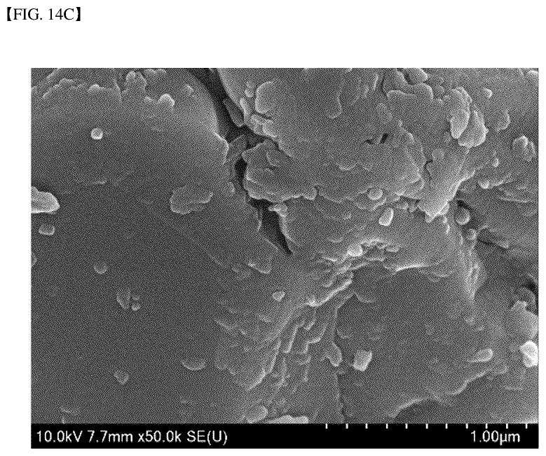

A product was obtained in the same manner as in Preparation Example 2, except that NCM622 (Ni 60-Co 20-Mn 20) was used as a precursor and the calcination temperature was set to 950° C. A microscope image of the used precursor is shown in FIG. 13, and microscope images of the calcined product are shown in FIGS. 14A to 14C. FIGS. 14A to 14C are images at 1,000×, 10,000×, and 50,000×, respectively.

Referring to FIGS. 14A to 14C, the obtained product, e.g., the lithium metal composite oxide has a single particle. The average particle diameter of the single particle was about 4.0 μm.

### Preparation Example 5

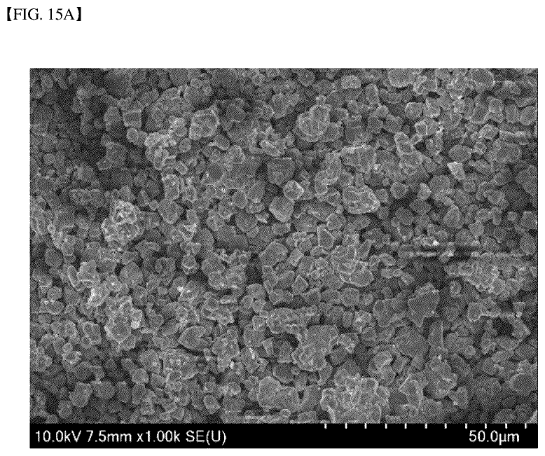

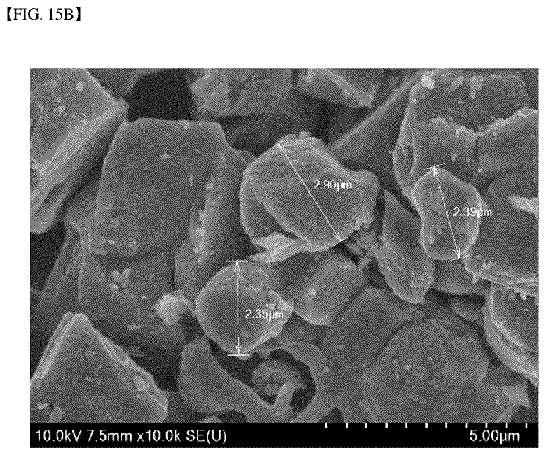

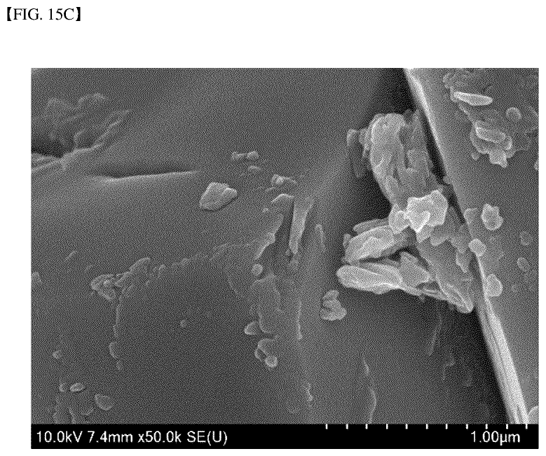

A product was obtained in the same manner as in Preparation Example 4, except that a precursor and lithium nitrate were mixed in a weight ratio of 1:1.2. Microscope images of the calcined product are shown in FIGS. 15A to 15C. FIGS. 15A to 15C are images at 1,000×, 10,000×, and 50,000×, respectively.

Referring to FIGS. 15A to 15C, the obtained product, e.g., the lithium metal composite oxide, has a single-particle structure. The average particle diameter of the single particles was about 4.0 μm.

### Comparative Example 1

NCM811 purchased from P company and lithium nitrate were mixed in a weight ratio of 1:1, and calcined 800° C. for 30 minutes.

### Comparative Example 2

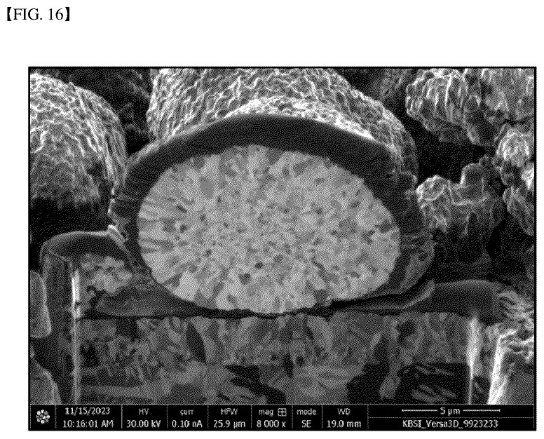

NCM811 used in Comparative Example 1 and lithium nitrate were mixed in a weight ratio of 1:1, and calcined at 800° C. for 20 hours. A microscope image of the calcined product is shown in FIG. 16.

Referring to FIG. 16, unlike Preparation Examples 2 and 3, it can be confirmed that the internal particles (primary particles) are not uniform, and particles on the outside have relatively large sizes, while particles on the inside have significantly smaller sizes. The sizes of the primary particles of the precursor increase as lithium ions permeate or diffuse, but, in the case of Comparative Example 2, it can be confirmed that lithium ions did not sufficiently permeate into the interior of the particles (secondary particles) despite a very long calcination.

### Comparative Example 3

NCM811 purchased from L Company and lithium nitrate were mixed in a weight ratio of 1:1, and calcined at 800° C. for 20 hours.

### Experimental Example 1

Charge-discharge experiments were performed using the lithium metal oxide particles obtained in Preparation Examples 2 and 3. Results are shown in Table 1.

TABLE 1

| | Specific capacity (mAh/g) | | | |
|---|---|---|---|---|
| | 1 Cycle | 2 Cycles | 3 Cycles | Efficiency (%) |
| Preparation | 196.46 | 172.88 | 171.86 | 87.48 |
| Example 2 | | | | |
| Preparation | 211.83 | 158.09 | 155.42 | 73.37 |
| Example 3 | | | | |
| Preparation | 167.53 | 132.00 | 130.77 | 78.06 |
| Example 4 | | | | |
| Preparation | 160.94 | 129.55 | 129.02 | 80.17 |
| Example 5 | | | | |

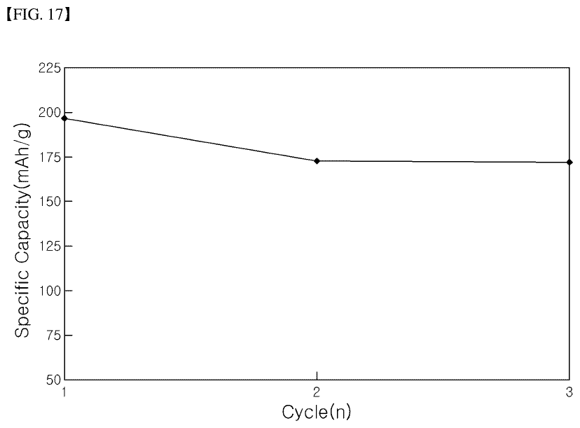

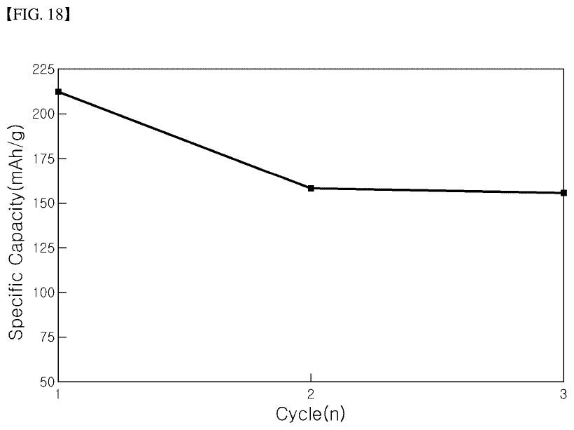

FIG. 17 illustrates a charge/discharge result of the lithium metal composite oxide of Preparation Example 2 having an average particle diameter of about 10 μm, and FIG. 18 illustrates a charge/discharge result of the lithium metal composite oxide of Preparation Example 3 having an average particle diameter of about 9 μm.

As can be seen from Table 1, FIG. 17, and FIG. 18, the charge/discharge results of the lithium metal composite oxides of Preparation Examples 2 to 5 exhibit good performance even when considering lithium-ion retention.

Here, Preparation Example 2 or 3 may be used as the first particles described in FIG. 9, and Preparation Example 4 or 5 may be used as the second particles described in FIG. 9.

### Experimental Example 2

Charge-discharge experiments were performed using the lithium metal oxides of Comparative Examples 1 to 3. Results are shown in Table 2.

TABLE 2

| | Specific capacity (mAh/g) | | | |
|---|---|---|---|---|
| | 1 cycle | 2 cycles | 3 cycles | Efficiency (%) |
| Comparative | 154.21 | 102.38 | 78.67 | 51.01 |
| Example 1 | | | | |
| Comparative | 217.45 | 187.04 | 186.9 | 85.95 |
| Example 2 | | | | |
| Comparative | 147.89 | 121.55 | 120.2 | 81.28 |
| Example 3 | | | | |

Referring to Table 2, it can be seen that for Comparative Example 1, which was calcined for about 30 minutes similar to the present disclosure, not only the energy capacity was low, but also the performance significantly deteriorated due to repeated charging and discharging.

In the case of Comparative Examples 2 and 3, which imitate commercial products, charge/discharge characteristics similar to those of the present disclosure were exhibited with calcination performed for a long time of more than 12 hours.

According to the embodiments of the present disclosure, lithium ions can be effectively permeated into, diffused into, injected into, bound to, or coated onto the precursor through ion-generating. Accordingly, the production time and cost of the cathode active material can be reduced.

The effects according to the embodiments of the present disclosure are not limited to the contents exemplified above.

Although the preferred embodiments have been described above, they are merely examples and not intended to limit any embodiments and it should be appreciated that various modifications and applications not described above may be made by one of ordinary skill in the art without departing from the embodiments.

Therefore, it should be understood that the scope of the present disclosure includes changes, equivalents, or substitutes of the technical concept described above. For example, each component specifically shown in the embodiment of the present disclosure may be modified and implemented. In addition, it should be understood that differences related to these modifications and applications are within the scope of the present disclosure.

What is claimed is:

1. A method of preparing a cathode active material, the method comprising:
a mixture preparation step of mixing a precursor with a lithium compound;
an ion-generating step of generating lithium ions from the mixture so that the lithium ions permeate into the precursor; and
a calcination step of calcining the precursor into which the lithium ions have been permeated.

2. The method according to claim 1, wherein the ion-generating step comprises an electric field application step of applying an electric field or a magnetic field to the mixture.

3. The method according to claim 1, wherein the ion-generating step further comprises a liquefaction step of heating the precursor and the lithium compound to melt at least a portion of the lithium compound, before the electric field application step.

4. The method according to claim 1, wherein the mixture preparation step further comprises:
a step of heating the precursor, and
a step of mixing the heat-treated precursor with the lithium compound, and
wherein the ion-generating step further comprises:
a liquefaction step of secondarily heating the mixture of the precursor and the lithium compound to melt at least a portion of the lithium compound.

5. The method according to claim 1, wherein the lithium compound comprises one or more of Li₂CO₃, LiOH, LiNO₃, Li₂S, LiZO, Li₃PO₄, LiC₂H₃O₂, LiF, Li₃N, or a mixture thereof.

6. The method according to claim 1, wherein the prepared cathode active material comprises one or more of NCM, NCA, NCMX, LFP, LMFP, LMFPX, LTO, LMO, LNMO, LCO, or a mixture thereof.

7. The method according to claim 2, wherein the ion-generating step further comprises a step of heat-treating the mixture before or after the electric field application step.

8. The method according to claim 1, wherein the calcination step is initiated when a molar number (mol) of lithium ions relative to a molar number of the precursor is equal to or less than a reference value as a result of the ion-generating step.

9. The method according to claim 1, wherein the ion-generating step is performed for 10 minutes or less, and
the calcination step is performed for 1 hour or less.

10. The method according to claim 9, wherein the mixture preparation step or the ion-generating step further comprises a dopant introduction step,
wherein the dopant is at least one element selected from among Al, Ni, Co, Mn, Mg, Na, Si, Cr, Fe, Sr, V, Zn, W, Zr, B, Ba, Sc, Cu, Ti, Mo, P, F, Ga, Ge, As, Se, Br, Nb, Tc, Ta, Y, La, Ru, Sn, Sm, Ca, In, S, and a combination thereof.

11. A cathode active material produced by preparing a mixture of a precursor and a lithium compound and applying an electric field or a magnetic field to the mixture so that lithium ions are permeated into the precursor, and performing a calcination process.

12. The cathode active material according to claim 11, wherein the cathode active material comprises first particles and second particles,
wherein the first particles have a multi-particle structure in which single particles are aggregated, and
the second particles have a single-particle structure.

13. The cathode active material according to claim 12, wherein the first particles have an average particle diameter of about 5.0 μm to 15.0 μm, and
the second particles have an average particle diameter of about 2.0 μm to 5.0 μm.

14. The cathode active material according to claim 13, wherein the cathode active material is generated by applying an electric field of 400 V/m or higher to the precursor for 5 minutes or more.

15. A cathode active material, comprising first particles and second particles,
wherein the first particles have a secondary particle structure in which a plurality of primary particles are aggregated, and
in any of the first particles, the primary particles have a uniform average particle diameter throughout.

16. The cathode active material according to claim 15, wherein the primary particles have an average particle diameter of about 0.6 to 3.0 μm, and
the secondary particles have an average particle diameter of about 5.0 to 15.0 μm.

17. The cathode active material according to claim 15, wherein a density of lithium ions in the first particles is evenly distributed throughout.

18. The cathode active material according to claim 15, comprising:
a first region located at a center of each of the first particles, and
a second region located on an edge side of the first region,
wherein a ratio of an average particle diameter of primary particles in the second region to an average particle diameter of primary particles in the first region is from 0.8 to 1.2.

19. The cathode active material according to claim 15, wherein the first particles further comprise a shell portion surrounding the secondary particle,
both the primary particles and the shell portion comprise lithium ions, and
the primary particles and the shell portion comprise an identical transition metal element.

20. The cathode active material according to claim 15, wherein the first particles or the second particles comprise a coating layer formed on surfaces thereof, and a content of the coating layer is from 0.4 to 1.0 wt % based on a total weight of the cathode active material,
wherein the coating layer comprises B, Al, P, Si, Ti, Mg, W, Y, Sr, Na, Cu, Fc, Ca, Zr, Nb, Ba, Co, Mn, or a combination thereof.
